(19) United States
(12) Patent Application Publication
(10) Pub. No.: US 2011/0269357 A1
(43) Pub. Date: Nov. 3, 2011

(54) BUOYANT MEMBER

(75) Inventor: John Carroll, Rochester (GB)

(73) Assignee: SUNDRIDGE HOLDINGS LIMITED, Rochester, Kent (GB)

(21) Appl. No.: 12/678,042

(22) PCT Filed: Aug. 29, 2008
(86) PCT No.: PCT/GB2008/002946

§ 371 Date: Mar. 15, 2010

(30) Foreign Application Priority Data
Sep. 14, 2007 (GB) 0717914.6

(51) Int. Cl. B63C 9/08; B32B 5/18; B32B 3/26

(52) U.S. Cl. 441/88; 428/158

(57) ABSTRACT

A buoyant member comprising a sheet or shaped panel of flexible or pliable, mainly closed cell foam material for forming at least part of a garment to provide buoyancy therefor, wherein the foam material has a density less than water, and the sheet or shaped panel has a plurality of fold lines and a plurality of separated portions or “islands” of foam material provided or formed without removal or cutting of foam material, such as by high frequency welding techniques (such as ultrasonic welding action) so as to have the effect of making denser fold lines but the whole sheet more flexible than the buoyant foam material and to increase the overall flexibility of the sheet or shaped panel.

The present invention concerns a buoyant member for forming part of a garment and a garment containing such functioning as a buoyancy aid.

Buoyancy aids which use closed cell foam plastic having a density less than water i.e. which float/are buoyant in water, are already well-known as a means of helping to reduce the risk of drowning in the event of accidental immersion in water.

The known aids are normally constructed from sheets or shaped panels of closed foam plastic which are stitched into the lining of a vest, jacket or overall to provide permanent buoyancy. The disadvantage of this method of construction is that the closed cell foam plastics is much stiffer that the materials from which the outer shell and lining are constructed and as a consequence these garments can be cumbersome and uncomfortable.

In JP10337797 an attempt to overcome the problem is made by cutting lines in the foam in at least two directions but such reduces the strength of the sheet of plastics foam and is costly in production.

According to the present invention there is provided a buoyant member comprising a sheet or shaped panel of flexible or pliable, mainly closed cell foam plastics material for forming at least part of a garment to provide buoyancy therefor, wherein the foam material has a density of less than water, and the sheet has a plurality of fold lines and a plurality of separated portions of foam material or “islands” provided or formed so as to have the effect of making the fold lines more flexible than the buoyant foam material islands and/or to increase the overall flexibility of the sheet or shaped panel, wherein the fold lines have been formed by using a high frequency welding technique or machine (such as ultrasonic welding) and/or by application of heat and/or pressure or other process not involving removal or cutting of material.

Preferred features of the invention are as described in subsequent claims 2 to 19. Normally, a single sheet or shaped panel of foam material constitutes the buoyant member or if a laminate is provided such will not be provided with air pockets or cavities between the sheets.

Thus the present invention overcomes or mitigates many of the known problems of buoyancy aid garments by using a closed cell foam plastic in sheet or shaped panel form which has been pre-formed into a more flexible or more foldable grid-like or lattice/matrix structure. The flexible/fold lines are preferably achieved by using high frequency welding devices or techniques to melt or soften the foam material and which by heat and/or pressure re-configures the flat sheet or shaped panel of closed cell foam plastic into a grid-like structure which can fold or bend along the welded or heated lines. Other means for increasing the flexibility are also envisaged such as claimed in claim 2 or 14. A reduction in thickness of the previous foam sheet material normally results and with a consequential increase in density of the resultant treated material relative to the untreated foam material.

The grid-like structure may be of square, rectangular, cruciform, triangular or any other shape that allows the foamed sheet to fold or flex along the welded or other formed fold lines.

The foldable, grid-like appearance sheets or shaped panels can then be cut to shape and fitted to e.g. a vest, jacket or overall or other garment, by means of stitching, gluing or other means giving several benefits to the wearer.

(1) The resultant garment is softer, more flexible and more comfortable to wear.

(2) The welded/heated or otherwise formed fold lines increase the tensile strength of the sheets or shaped panels of closed cell foam plastics material.

(3) Because the fold lines may generally be only approximately 3 mm wide, the inherent buoyancy of the sheet or panel of closed cell foam plastic is only slightly reduced by the welding/heating or other fold line forming process.

Thus the present invention provides an advantageous foldable articulated flotation foam buoyancy aid

The invention will be described further, by way of example, with reference to the accompanying drawings in which:

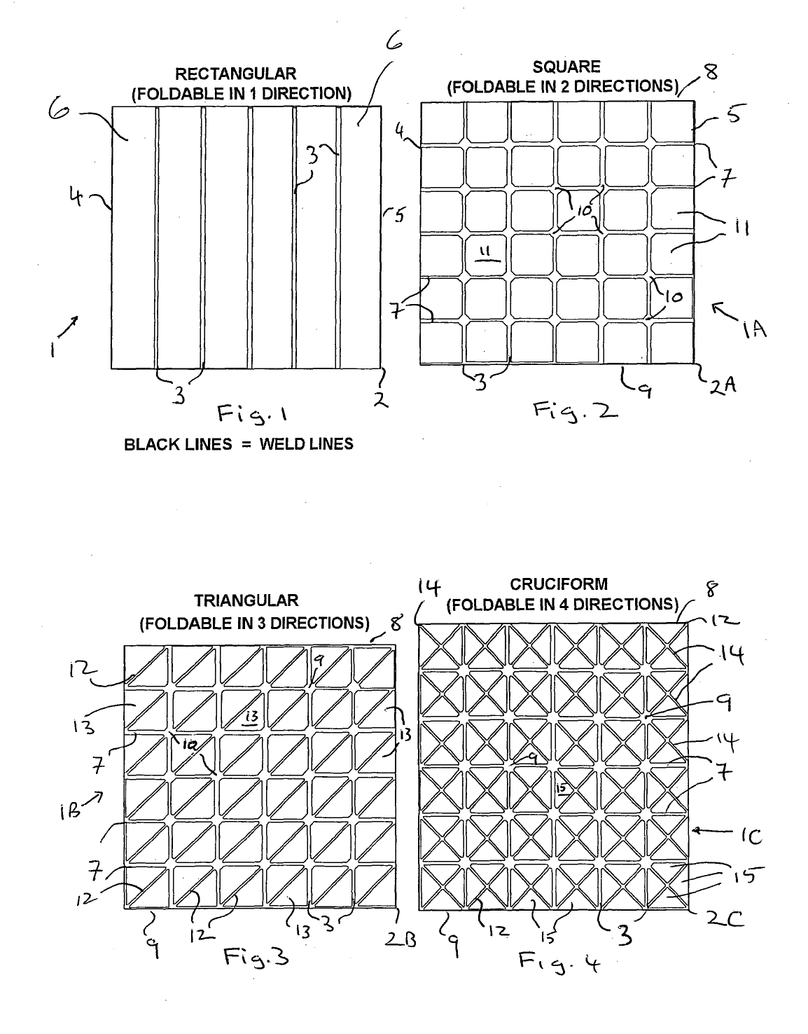

FIG. 1 is a plan view of a buoyant member forming a first embodiment of the invention;

FIG. 2 is a plan view of a buoyant member forming a second embodiment of the invention;

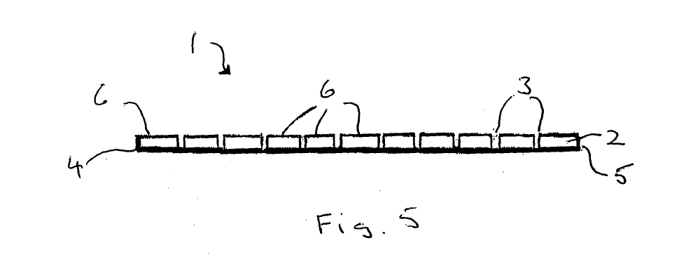

FIG. 3 is a plan view of a buoyant member forming a third embodiment of the invention;

FIG. 4 is a plan view of a buoyant member forming a fourth embodiment of the present invention; and

FIG. 5 is an end elevation of the member of FIG. 2 looking along the weld lines.

In simple embodiments of the invention shown in FIG. 1 and FIG. 2, a foldable articulated floatation foam buoyancy aid or buoyant member 1 and 1A comprises a square flat sheet 2 of buoyant closed cell foam plastics material with a density of less than water for forming part of a garment (not shown) to provide buoyancy therefor.

The foam material in all the embodiments is formed of closed cell foam plastics material of less density than that of water and may be formed of any suitable plastics material, for example, EVA or PVC or PE foam. The sheet 2 will be in the example of an original thickness of approximately 6 mm or 7 mm

As shown in the embodiment of FIG. 1 of the drawings, a plurality of spaced apart parallel fold lines 3 forming a first group of fold lines extending parallel to first opposite sides 4, 5 of the sheet 2 are provided in the sheet material and form elongate rectangular, separated foam portions or long “islands” 6. The buoyant member 1A is more foldable in one direction.

In the embodiment of FIG. 2 a sheet 2A of buoyant closed cell foam material is provided and which includes the structure of FIG. 1, and also includes a plurality of spaced apart parallel fold lines 7 which are additionally provided in the sheet and extending parallelly to the other, second, opposite sides 8 and 9 of the sheet and intersecting with the first group of fold lines 3 at right angles to form intersections 10 to define a grid or matrix of square separated foam material portions or “islands” 11 of the original thickness of the sheet material 2A which latter is thus more foldable in two directions.

In the embodiment of FIG. 3, a buoyant member 1B is also formed of a sheet 2A of closed cell foam material of less density than that of water is formed similarly to that of FIG. 1 and FIG. 2 except that, additionally, a third group of spaced apart parallel and this time inclined fold lines 12 are formed in a similar manner and action but extending at 45 degrees to the sides 4 of the sheet and intersecting the points of intersection 10 of the first and second groups of the fold lines 3 or 7, to form a grid or matrix this time of triangular, remaining full thickness separated foam material portions or “islands” 13. This sheet 1B is more foldable in three directions.

In the embodiment of FIG. 4 a sheet 2C of closed cell foam material is formed similarly to FIGS. 1, 2 and 3 except that a fourth group of spaced apart oppositely inclined fold lines 14 are additionally provided extending at 45 degrees to sides of the sheet and to lines 3, 7 but intersecting the third group of inclined fold lines 12 at 90 degrees and also having common intersection regions 9 with the first and second groups of fold lines 3, 7 and 12 to form a more complex lattice of smaller triangular separated portions or “islands” 15 of full thickness foam material. The sheet 1C is more foldable in four directions.

Thus the embodiment of FIG. 1 provides “long islands” or separated portions 6 of foam material, whilst that of FIG. 2 provides spaced, square separated portions or “islands” 11 of closed cell plastics sheet material, whilst that of FIG. 3 provides triangular separated portions or “islands” 13 and whilst that of FIG. 4 provides a cruciform or smaller triangular separated portion or “islands” 15 of full thickness foam material and the resultant sheet material 2, 2A, 2B and 2C has increased overall flexibility relative to a sheet of closed cell foam material without any fold lines or otherwise reduced thickness lines.

In FIGS. 1 to 5 the fold lines are preferably provided by high frequency welding techniques, although any suitable means may be provided to reduce the thickness of the material or otherwise to increase the overall flexibility of the sheet. In a preferred operation, the high frequency electrical welding tool is energised and the hot member pressed against the foam sheet material to form the at least one group of fold lines with the resultant material of the thus formed fold line being of reduced thickness and in the order of approximately 1 mm from a sheet of approximately 6 or 7 mm thickness with a width of approximately 3 mm and such as to provide for increased or enhanced flexibility of the overall sheet relative to a sheet not having any such fold lines formed. A grid-like welding tool (or one of any other pattern such as shown in the drawing) may be used having parallel lines intersecting which produce the channels or grooves forming the fold lines in the foam. The foam material structure in the fold line region may cease or substantially cease to exist as a result of the heating etc and will normally increase in density relative to the foam material.

It is to be appreciated that each of the embodiments is formed from a single sheet or shaped panel and single layer of closed cell foam plastics material. For use in a garment, the sheet or shaped panel of material, as necessary, will be secured in a garment, such as a jacket, by suitable means such as stitching, gluing or otherwise bonding to increase the buoyancy of the garment (not shown). Also, according to the present invention is the method of so increasing the flexibility of a buoyant garment.

1. A buoyant member comprising a sheet or shaped panel of flexible or pliable, mainly closed cell foam material for forming at least part of a garment to provide buoyancy therefor, wherein the foam material has a density less than water, and the sheet or shaped panel has a plurality of fold lines and a plurality of separated portions or “islands” of foam material provided or formed so as to have the effect of making the fold lines more flexible than the buoyant foam material islands and/or to increase the overall flexibility of the sheet or shaped panel and wherein the fold lines of increased flexibility are formed by application of heat and/or pressure and/or by using a high frequency welding technique or machine or by application of a ultrasonic welding technique or other suitable means or method to modify the foam material without the removal or cutting of foam material.

2. A buoyant member as claimed in claim 1, in which the application of heat and/or pressure reconfigures a sheet or shaped panel of closed foam material into a grid-like or lattice structure or pattern which sheet or shaped panel is foldable or flexible along the fold lines.

3. A buoyant member as claimed in claim 1, in which the fold lines form a grid-like or lattice structure or pattern of square, rectangular, cruciform, triangular or any other shape that allows the foam sheet or shaped panel to fold along the welded or other fold lines.

4. A buoyant member as claimed in claim 1, in which at least one group of a plurality of parallel spaced more flexible fold lines are provided.

5. A buoyant member as claimed in claim 1, in which first and second groups of spaced apart, parallel fold lines are provided intersecting at right angles to form a grid-like or lattice pattern.

6. A buoyant member as claimed in claim 5, in which a third group of parallel spaced apart parallel fold lines is provided intersecting each of the first and second groups, preferably at 45°, and extending through the points of intersection of the first and second line groups.

7. A buoyant member as claimed claim 6, in which a fourth group of parallel spaced apart fold lines is provided intersecting the third group of fold lines at 90° and extending through the points of intersection of the first and second groups of fold lines.

8. A buoyant member as claimed in claim 1, in which the sheet or shaped panel with fold lines is fitted to the garment (which may, for example, be a vest, jacket or overall), by any suitable means (such as stitching, gluing or other means), thus providing buoyancy benefit to the wearer when in water.

9. A buoyant member as claimed in claim 1, in which the fold lines are of approximately 3 mm width.

10. A buoyant member as claimed in claim 1, in which the fold lines do not exceed 20 mm width.

11. A buoyant member as claimed in claim 1, in which the foam material sheet or shaped panel is approximately 2 mm to 20 mm thick and reduced to approximately 1 mm thickness in the fold lines where the material is of increased flexibility relative to the foamed regions.

12. A buoyant member as claimed in claim 1, in which the sheet shaped panel is more flexible along the fold lines and/or overall in one, two, three, four or more directions.

13. A buoyant member or a garment whenever including a buoyant member substantially as herein described with reference to the FIG. 1, 2,3 or 4 of the accompanying drawings.

14. A buoyant member of sheet or shaped panel material as claimed in claim 1, whenever in combination with a garment.

15. A lifejacket or buoyancy aid article of clothing whenever including a buoyant member as claimed in claim 1.

16. A method of improving the flexibility of a buoyant article of clothing or garment including at least one sheet or shaped panel of buoyant closed-cell foam material, comprises pre-forming the or each sheet or shaped panel to have a plurality of fold lines of increased flexibility relative to the remainder of the sheet or to be as claimed in claim 1, and incorporating such in the article of clothing or garment.

17. A buoyant member as claimed in claim 1 or a garment including such, wherein only a single sheet or shaped panel of closed cell foam material comprises said member.

18. A buoyant member as claimed in claim 1, in which the fold lines are formed from solid or substantially solid, non-foamed plastics material produced by applying heat and/or pressure to the closed cell foam plastics material.
